(19) United States
(12) Patent Application Publication
(10) Pub. No.: US 2016/0379168 A1
(43) Pub. Date: Dec. 29, 2016

(54) Optimized Capacity Matching for Transport Logistics Accounting for Individual Transport Schedules

(71) Applicant: SAP SE, Walldorf (DE)

(72) Inventors: Theodor Foerster, Mannheim (DE); Jakob Moellers, Muenster (DE); Petra Hochstein, Duesseldorf (DE)

(21) Appl. No.: 14/754,559

(22) Filed: Jun. 29, 2015

(51) Int. Cl. G06Q 10/08; G06Q 10/06

(52) U.S. Cl. CPC G06Q 10/08355; G06Q 10/063116

(57) ABSTRACT

An ad-hoc logistics solution can identify optimal solutions for the spatio-temporal problem of adding a transport to the route calendar of a transport vehicle.□ For example, an initial set of transport assignments that may be added to a route calendar of a driver of a vehicle can be identified by eliminating potential transport assignments for which the vehicle does not meet equipment and/or accessibility criteria for a location associated with the potential transport assignment, and suggestions can be found for insertion of a candidate transport assignment from the initial set of transport assignments into the route calendar. The suggestions can be validated by applying a set of constraints to determine whether each suggestion is feasible and then ranked such that a highest ranked suggestion is placed into the route calendar.

### TECHNICAL FIELD

The subject matter described herein relates to an automated system for providing suggestions for ad-hoc transportation assignments.

### BACKGROUND

Efficient and agile processes in transport logistics can be important success factors for companies or other entities in the transportation business. As transport logistics is an increasingly relevant factor in modern economy, optimizing the efficiency of carriers is a relevant topic. From an economic perspective, it is beneficial to use available resources such as trucks as efficiently as possible. Furthermore, ecological motivations underline the importance of, for example, avoiding empty runs of trucks. Unforeseen problems can occur during the planning or execution of road transports: trucks can break down, sudden changes in transport demands or orders may occur, etc. In such situations, it can be important that all parties of the supply chain are able to react in a flexible and agile manner to mitigate any issues.

More generally, increasing the utilization ratio of transport capacity can be desirable for any transport company (e.g. a shipping company or other organization that provides transportation and/or cargo delivery services either internally or as a third party service to other businesses) running a profitable business as well as for reducing the environmental footprint per shipped good. In this context, the utilization ratio is the amount of used transport capacity (e.g. cargo space) divided by the total available transport capacity. Alternatively, the utilization ratio is unused transport capacity divided by the total available and subtracted from 1. Broking and/or sharing of available transport capacity with other businesses can be a strategy for maximizing utilization ratios. In case of sharing of available transport capacities between different businesses, it can be necessary to optimize transport schedules between the sharing businesses. This sharing can be referred to as formation of a collaborative business logistics network.

### SUMMARY

In one aspect, a method includes identifying an initial set of transport assignments that may be added to a route calendar of a driver of a vehicle, finding suggestions for insertion of a candidate transport assignment from the initial set of transport assignments into the route calendar, validating the suggestions by applying a set of constraints to determine whether each suggestion is feasible, ranking the list of feasible suggestions based on one or more ranking criteria, and inserting a highest ranked suggestion from the list into the route calendar. The identifying includes eliminating a potential transport assignment for which the vehicle does not meet equipment and/or accessibility criteria for a location associated with the potential transport assignment. The finding includes inserting the candidate transport assignment in all possible temporal combinations with one or more existing transport assignments in the route calendar. The validating results in a list of feasible suggestions.

In some variations one or more of the following features can optionally be included in any feasible combination. The method can further include accessing the route calendar from a mobile device of the driver and/or a cloud based service used by the driver. The set of constraints can include both temporal feasibility and spatio-temporal feasibility. The set of constraints can further include compliance with one or more driving time regulations. The validating can include a recursive process via which all of the suggestions are considered. The ranking criteria can include profit and risk.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating participants in an ad-hoc logistics network;

FIG. 1 shows a process flow chart illustrating features of a method consistent with implementations of the current subject matter;

FIG. 2 and FIG. 3 show screenshot views illustrating features of a driver data input screen;

FIG. 4 and FIG. 5 show screenshot views illustrating features of a transport assignment publication input screen;

FIG. 6 shows a screenshot view illustrating a search view that can be presented to a driver via a user interface;

FIG. 7 shows a screenshot view illustrating a confirmation screen for presenting an updated route schedule for a driver;

FIG. 8 shows a screenshot view illustrating a detail screen for presenting information about a pick-up location added to an updated route schedule for a driver;

FIG. 9 shows a screenshot view illustrating an automatically adjusted router calendar including a newly added transport assignment for a driver;

FIG. 10 shows a table illustrating a validation components overview consistent with implementations of the current subject matter and an advantageous ordering of the validations in the transport management system and frequency of calling of the check;

FIG. 11A shows a calendar view illustrating an example of features consistent with implementations of the current subject matter;

FIG. 11B shows a tree structure illustrating testing of suggestions for the example of FIG. 11A;

FIG. 12A shows a calendar view illustrating another example of features consistent with implementations of the current subject matter;

FIG. 12B shows a tree structure illustrating testing of suggestions for the example of FIG. 12A;

FIG. 13 shows an example of a pseudocode snippet;

FIG. 14 shows a table illustrating an overview on parameters for an equipment check

FIG. 15 shows a diagram illustrating a load order example;

FIG. 16 shows a chart illustrating an example of two alternate suggested route plans for addition of a same additional transport assignment to an existing route calendar for a driver;

FIG. 17 shows a table illustrating an example route calendar for a driver with each location having an earliest and a latest time of arrival.

FIG. 18 shows a debugging output for a time constraints test consistent with implementations of the current subject matter;

FIG. 19 shows a simplified pseudocode snippet illustrating how a time constraints test consistent with implementations of the current subject matter can be implemented;

FIG. 20 shows a computing architecture that can be used with some implementations of the current subject matter; and

FIG. 21 shows a process flow diagram illustrating aspects of a method having one or more features consistent with implementations of the current subject matter.

When practical, similar reference numbers denote similar structures, features, or elements.

### DETAILED DESCRIPTION

Implementations of the current subject matter can include the ability to offer additional transports in an electronic marketplace. Truck drivers (a term used herein to describe operators, managers, or owners of transport vehicles, which can include trucks, vans, cars, bicycles, or other ground vehicles; airplanes, helicopters, other flying vehicles; boats, ships, or other waterborne vehicles; etc.) from third party carriers can conduct the problematic transport. On the one hand, this situation is beneficial to carriers, because they use their resources (trucks) more efficiently. On the other hand, it is advantageous to the dispatchers, who can execute their transports although the initial carrier is unable to transport the cargo.

Currently available solutions generally do not consider optimizing transport networks automatically by taking individual travel schedules (e.g. target pickup and dropoff times or time ranges, locations, travel time, etc.) of drivers into account. Existing approaches are generally tedious, error prone, and/or inefficient, and can include searching suitable time slots for additional transports, manually maintaining schedules, and reliance on significant trial and error experience to create transport schedules. In particular, when updating transport schedules, existing follow up transports (e.g. additional delivery or pickup runs to which a driver has already committed) need to be considered and incorporated into a unified plan such that the driver can feasibly fulfill his or her existing commitments (e.g. existing transport agreements). Additionally, to participate in transport networks and marketplaces, truck drivers or dispatching officers need to maintain the transport schedules manually. For matching transport demand and available capacity, truck drivers and dispatching officers need to consider parameters such as the time slot for pick-up and delivery of the goods as well as the transport route (at least start and end point). It is possible that a set of transport demands may become invalid even as a viable schedule is developed as other companies may have covered the transport demand or the available capacity may have changed in the meanwhile.

Various solutions exist to address capacity matching for transport logistics. However, all generally focus on only a part or parts of the solution and do not take individual transport schedules of truck drivers into account. For example, ride-sharing services may neither take into account the transport schedule of drivers nor update a driver schedule automatically. Transport management solutions may fail to match transport capacity of external parties or to manage the transport schedules of these external parties. On-demand transport services may allow external drivers to search for new transports, but still require that transports are searched manually. An individual driver's transport schedule generally must be manually maintained and validated by the driver. Other available approaches may not offer support for external drivers (e.g. third-party transportation providers) or for integration of transport schedules for such drivers.

If a driver searches for an additional transport that he or she can conduct, the transport management system can evaluate the feasibility of transports contained in the database. For each transport, there may be multiple ways of inserting the additional transport into the driver's calendar because the sequence of loading locations is not predetermined. Due to the fact that the temporal parameters for every loading location are represented by a time interval from the earliest until the latest allowable time of arrival at the loading and/or unloading location, overlapping intervals result in a flexibility of arranging the locations in the calendar. An optimal sequence of loading locations can be derived to include all existing locations (e.g. pickup and dropoff locations) for assignments currently in the driver's route calendar plus the two new locations of an additional transport proposed for addition to the route calendar. The sequence in which those locations are ordered in the calendar determines whether the driver can reach all points in time, whether any constraints are violated, and how large the expected profit is for taking on the additional transport assignment. Finding a sequence with the shortest distance for the complete run and ordering the locations in a valid sequence therefore is a space-time problem. The transport management system finds and evaluates these different sequences, referred to herein as suggestions, to propose the best route calendar for all possible additional transports to the driver. Finding the most profitable tour plan for a set of given locations is the goal for the optimization that is conducted in the implementation.

Implementations of the current subject matter can address one or more difficulties present in existing solutions, for example by managing the transport capacity of an individual transport company or of a transport network (e.g. one that includes multiple companies or other otherwise unrelated transportation providers) to increase a utilization ratio of available transport capacity while decrease the risk of disrupting supply chains.

A transport management system consistent with implementations of the current subject matter can provide transport assignment offers that are suitable to the current transport capacity and to the current transport schedule of the particular truck driver or dispatching officer. Such a system can automatically analyze the individual transport schedules of one or more drivers or other transportation operators and can calculate suitable proposed transport assignments in real-time or near real time. After the dispatching officer or the driver has approved a proposed transport assignment and any associated potential adjustments of the transport schedule, the transport schedule is changed automatically. The changes of the individual transport schedule of each driver are immediately available and the transport management system guarantees that all transports in the calendar of the drivers—including the added transport—are feasible. All participants of the specific transport assignments (customer and carrier) are notified.

To provide these advantages, a transport management system can analyze one or more properties of a truck or other delivery or transport vehicle (e.g. its equipment, current location and its transport schedule) against open transport offers in the database. Additional features can include recursively providing different suggestions of how an additional transport could be integrated into a driver's current schedule of already committed transport assignments. Finding and validating of such suggestions can be performed by comparing each combination of transports with the transport schedule using an optionally parallelized recursive algorithmic approach on a tree-based data-structure to sort and evaluate the different combination of transport schedules resulting from the current transport demands and the existing transport schedule of the truck driver. If more than one suggestion is feasible multiple suggestions can be presented to the driver or other user accompanied by a rating according to a customizable cost function (e.g. calculating the transport costs per additional km that the transport vehicle must travel to complete a given transport assignment).

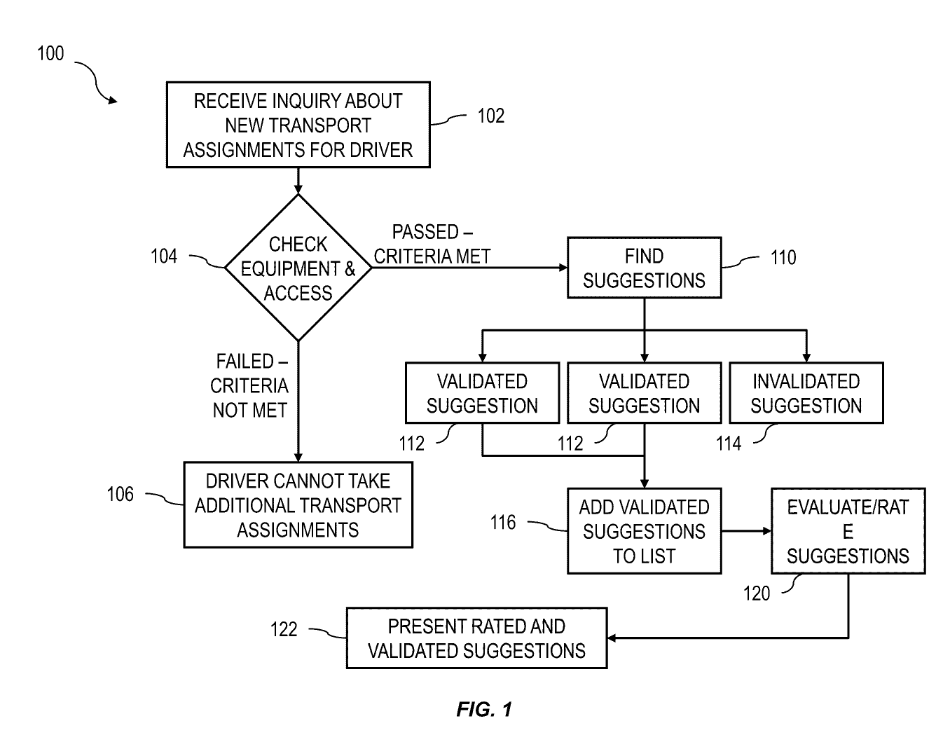

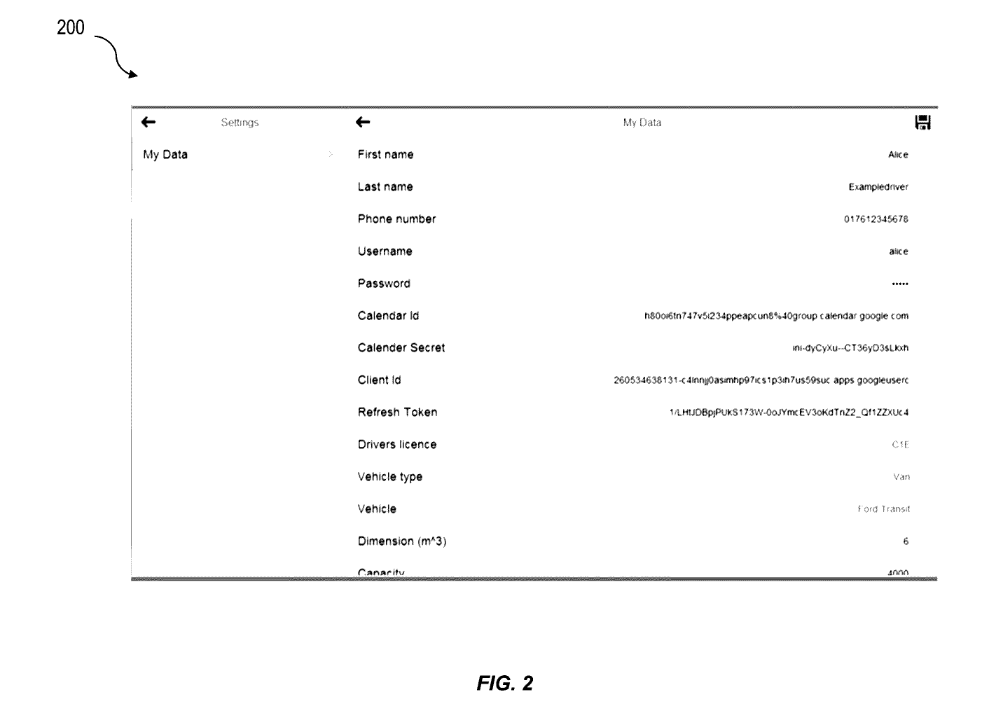

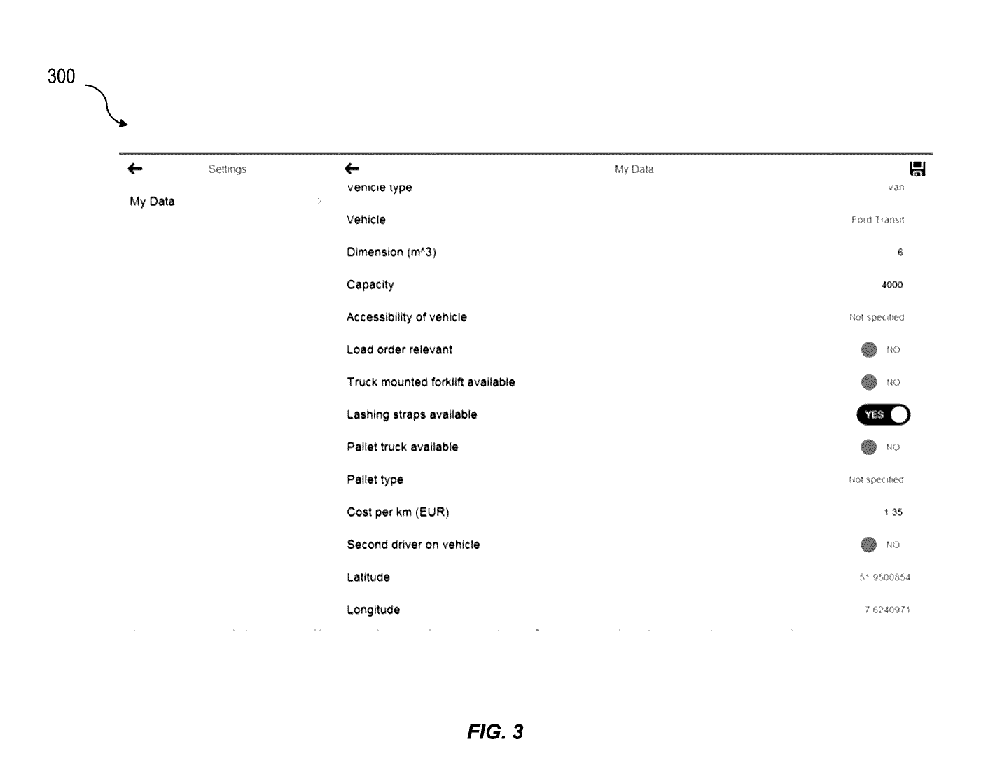

FIG. 1 shows a flow chart 100 illustrating features consistent with some implementations of the current subject matter. In general, and as described in greater detail below, properties of a truck or other transport vehicle (e.g. its equipment, current location and its transport schedule) are analyzed against transport offers maintained in a database. For example, at 102, an inquiry is received requesting new transport assignment offers for a driver. Data about the driver are compared to a set of initial approval criteria at 104. For example, a driver can provide information such as vehicle type (van, truck, car, type, tractor unit, tractor unit and semi trailer, etc.), other equipment available (e.g. loading lift platform, truck-mounted forklift, etc.), cargo capacity (e.g. volume and/or weight), driver credentials (e.g. insurance status, driver license information, etc.), current location, and the like. In some implementations of the current subject matter, a driver or a driver dispatcher can enter some or all of the driver data via a user interface such as that shown in the screenshot views 200, 300 of FIG. 2 and FIG. 3.

Returning to FIG. 1, if either of the driver and/or his or her vehicle fails the approval criteria comparison, the driver can be notified that he or she cannot take on any transport assignments at 106. If the comparison is passed, at 110 the transport management system finds suggestions for transport assignments for the driver. This process can include recursively generating different suggestions of how a candidate transport assignment can be integrated into a current route calendar of the driver. For example, required equipment of the transport assignment is checked against the available equipment of the truck (e.g. whether the truck have an included fork lift, whether cargo loading order is relevant for the vehicle, etc.) because this validation does not change for different calendar variations. The transport management system also evaluates requirements of the candidate transport assignment, such as for example loading and unloading times, equipment available at each point, location, size of item(s) to be shipped, exclusion on goods that cannot be shipped together (chemicals, hazardous materials, etc.), and the like. In addition, the transport management system can match pick-up and delivery times and locations of transport assignments with the particular transport schedule of the driver and/or the driver's current location. A suggestion finder process executing by the transport management system can perform some or all of the suggestion creation process. One or more suggestion finders can be configured to propose possible suggestions for the insertion of the candidate transport assignment in a route calendar for the vehicle. These suggestion finders can be implemented on a single processor or, alternatively, parallelized across multiple processors.

The features in FIG. 1 are identified by different hashing characteristics to show grouping into three types of activities: finding (vertical hashing), validating (horizontal hashing), and rating and/or evaluating (diagonal hashing) suggestions. The components and operations of the transport management system are advantageously arranged in a single, meaningful test and optimization approach that evaluates whether a driver can take an additional transport. Organization and sequencing of the operative components can influence system performance. For example, the complexity and computing resource consumption of the operations can vary significantly. Accordingly, fast checks that potentially reject a large number of transport assignment options are desirably conducted first such that more complex tests are implemented only for transport assignments that pass the simpler tests.

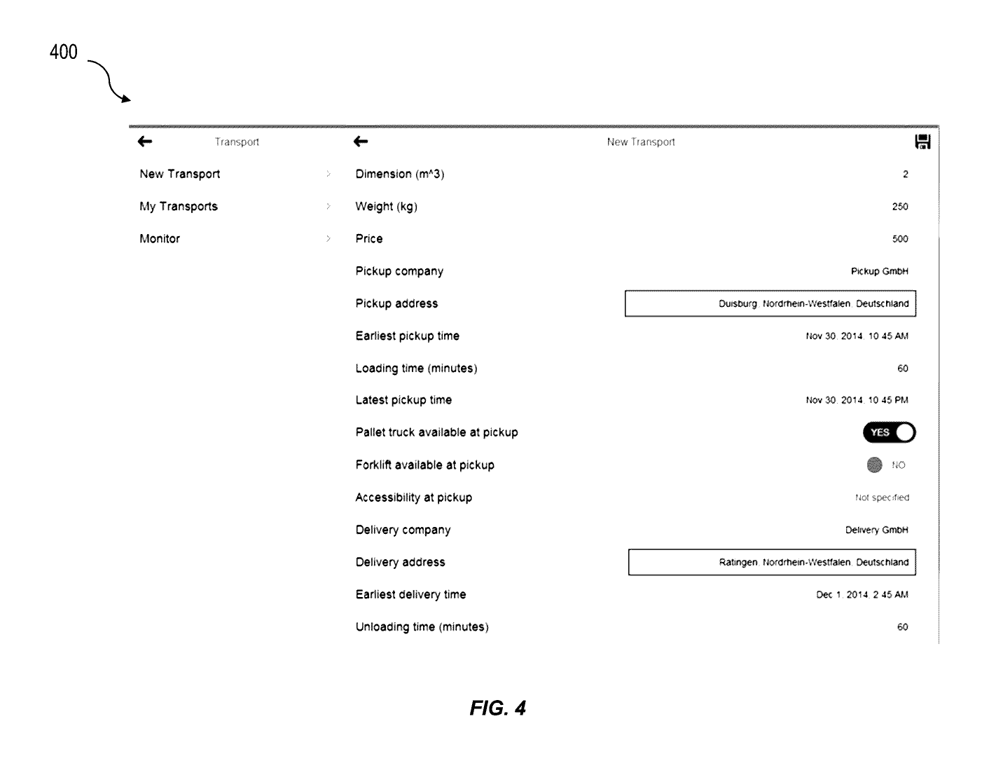

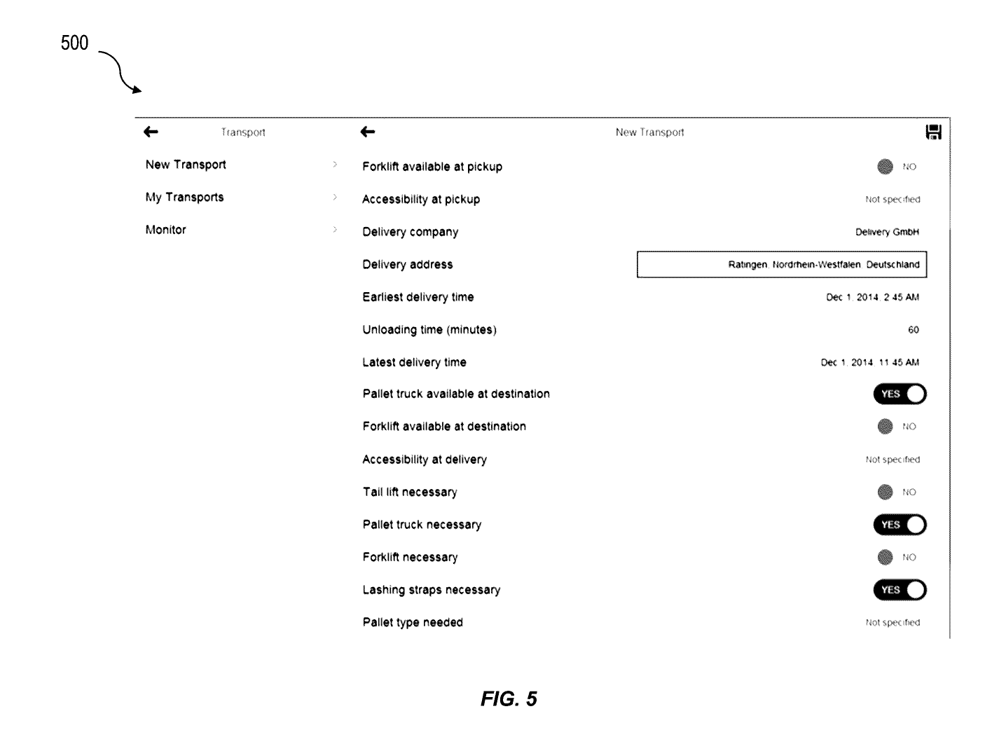

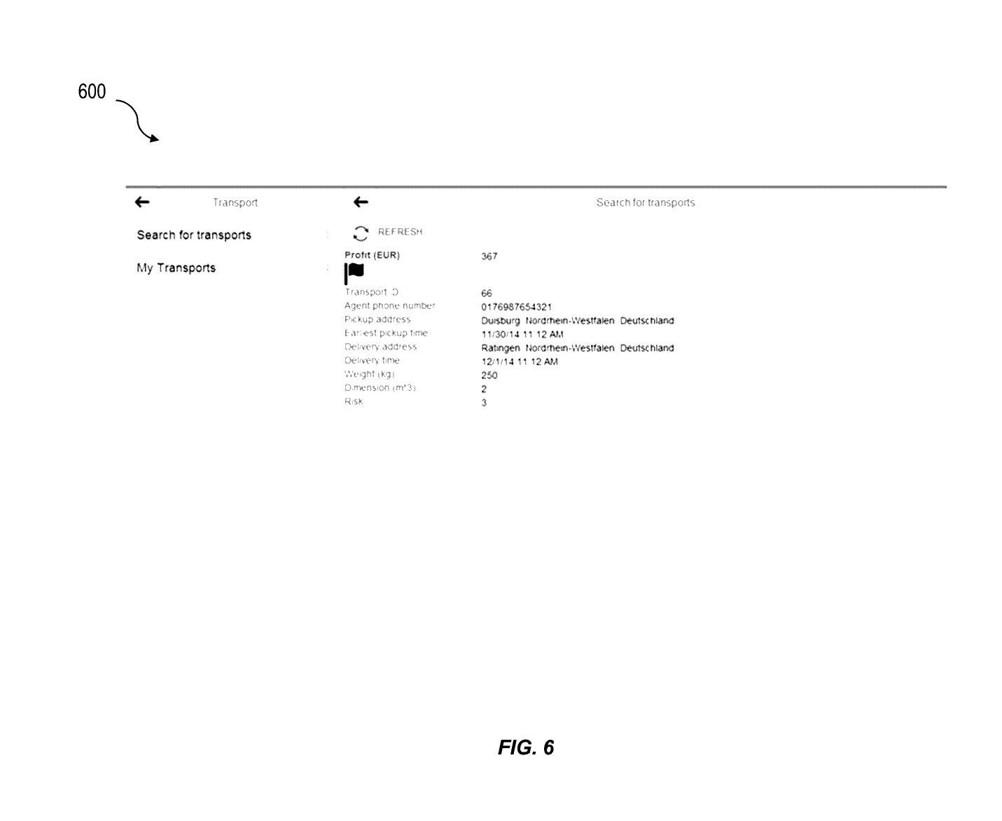

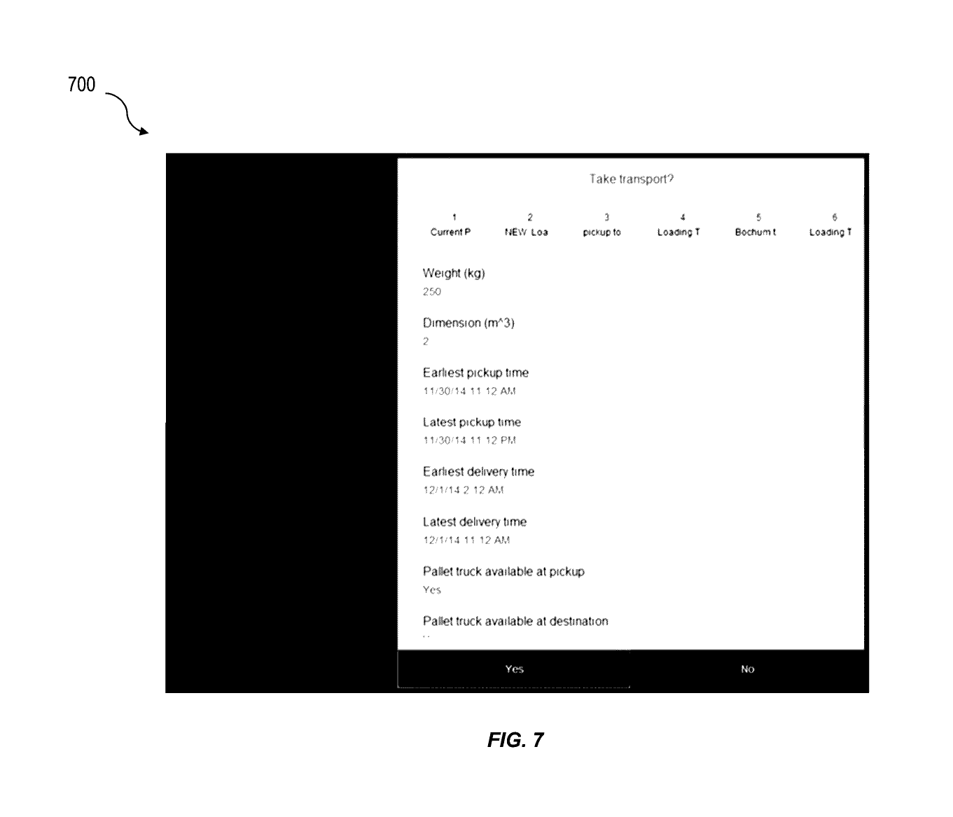

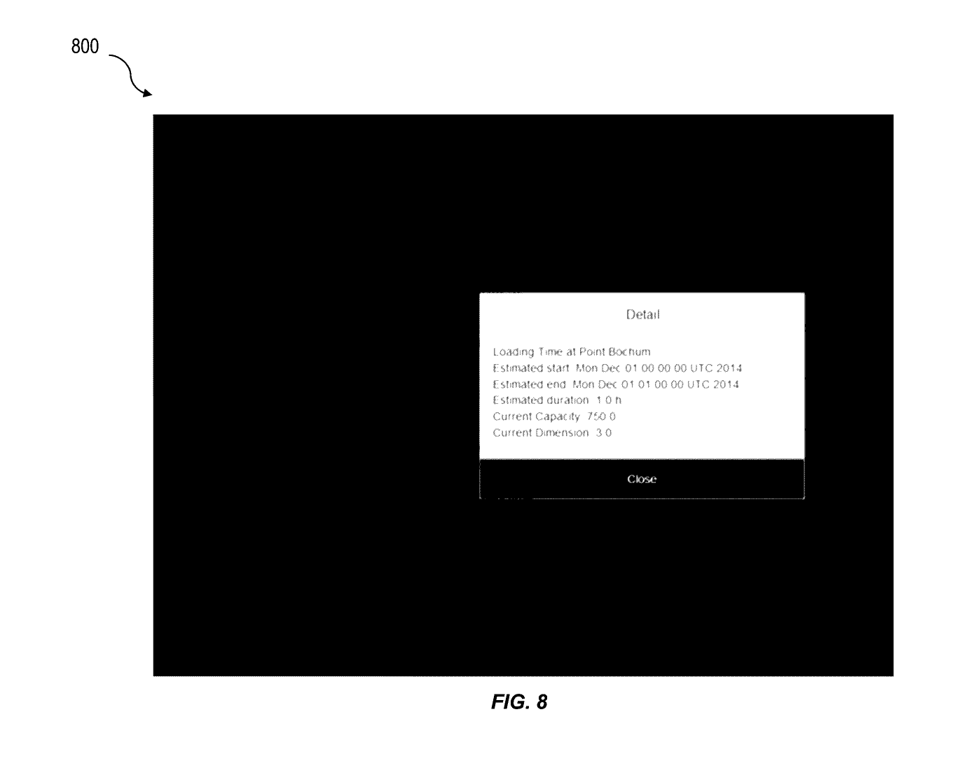

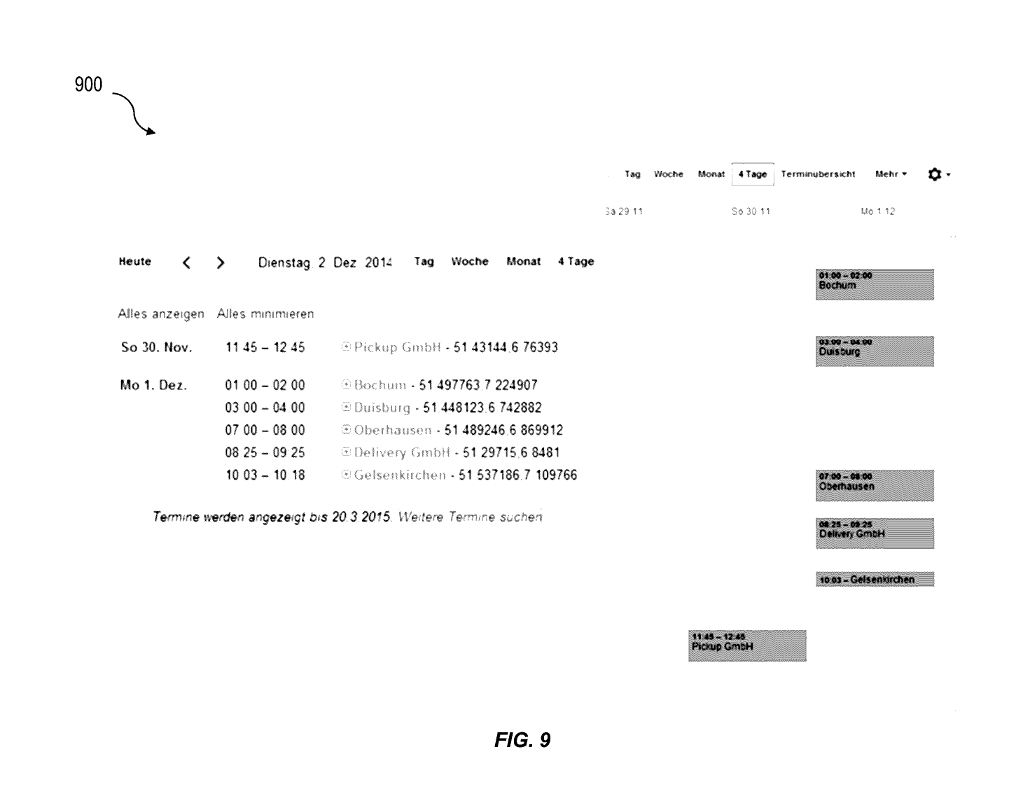

FIG. 4 and FIG. 5 show views 400, 500 illustrating an example user interface screen via which a carrier or some other company having transport assignments to be assigned can publish transport demand. FIG. 6 shows a view 600 of an example user interface screen illustrating a search view presented to a driver via a user interface to allow searching for a suitable transport for addition to the driver's route calendar. FIG. 7, FIG. 8, and FIG. 9 show views 700, 800, 900 respectively illustrating an example user interface screen via which a driver can view an updated route schedule, an example user interface screen via which a driver can view information about a pick-up location added to an updated route schedule for a driver, and an example user interface screen displaying an automatically adjusted router calendar including a newly added transport assignment for the driver.

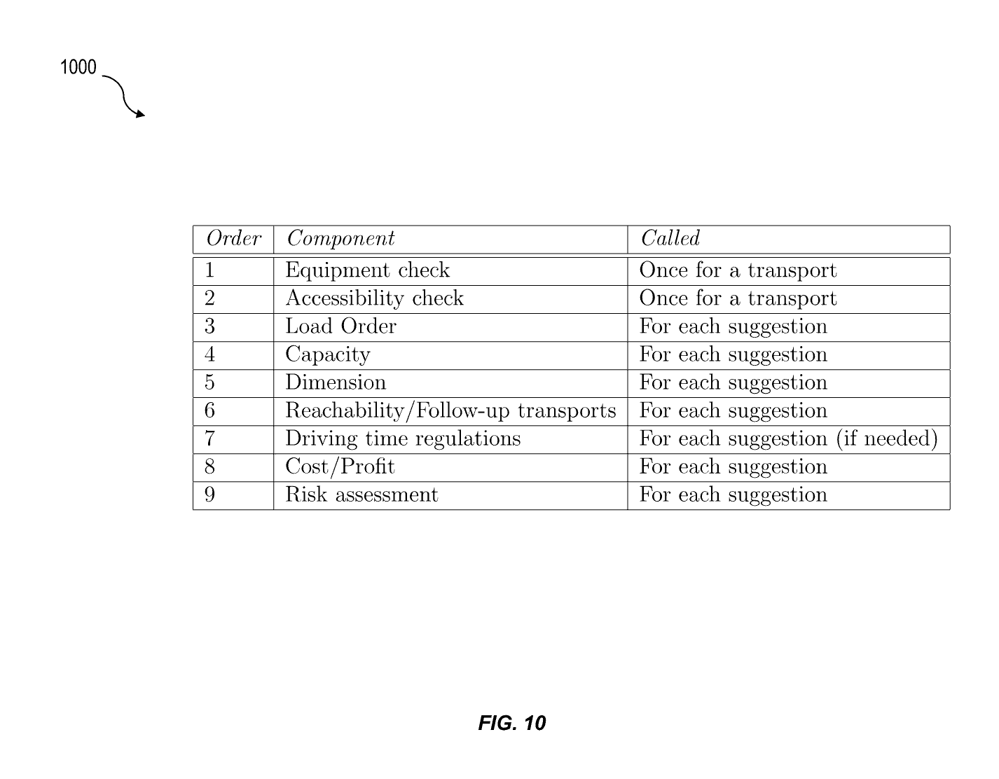

As it can be seen in FIG. 1, the checks for suitable equipment and accessibility (element 104) are executed before the first suggestions for the driver's route calendar are created. For these checks, no planning or scheduling mechanisms are needed. If equipment and accessibility validations are passed successfully, the process proceeds with finding of suitable suggestions of how the loading (and unloading) locations could be arranged in the driver's route calendar (element 110). The generated suggestions are validated by the checks listed in the table 1000 of FIG. 10 (e.g. checks 3-9). If a suggestion for a transport assignment passes all tests, it is added to the list of possible suggestions. The evaluating and/or rating of the suggestions in the list (element 12)) is performed based on one or more parameters discussed in more detail below. In some implementations of the current subject matter, a “best” suggestion can be returned based on this evaluation. Alternatively, more than one suggestion can be presented in a ranked order according to the evaluation and/or rating. In principle, a driver can accept a transport assignment as soon as one suggestion passes all tests. If more suggestions are applicable, the transport management system can provide a most profitable suggestion or an ordered list of suggestions. In implementations in which the evaluation criteria including a variety of factors (e.g. profit, risk, etc.), multiple suggestions can be presented via a user interface with functionality provided to order the provided suggestions according to a single criterion and/or by some aggregated ranking that includes more than one criteria.

As potential suggestions are created (or alternatively, when all possible suggestions are available), the transport management system can validate 112 or invalidate 114 a financial benefit of the suggestion for the driver and/or the driver's company while also determining potential threats that could disrupt the execution of the supply chain (e.g. quantifying risks of adding the suggestion to a driver's route calendar). Validating can include checking all constraints to evaluate whether a suggestion is feasible. When a suggestion passes all validations, its parameters such as estimated profit, rick, and other factors discussed in more detail below can be evaluated and/or rated relative to other suggestions to find and return the optimal suggestion. As such, validated suggestion are added to a list of suggestions at 116, evaluated and/or rated at 120, and presented at 122 (e.g. by display in a user interface displayed on a mobile device, computer, etc.

A transport management system can find and validate suggestions regarding a particular transport schedule either in a brute-force way (comparing each combination of transports with the transport schedule) or using a parallelized recursive algorithmic approach on a tree-based data-structure to sort and evaluate the different combination of transport schedules resulting from the current transport demands and the existing transport schedule of the truck driver. If a given driver can feasibly undertake more than one proposed transport assignment, the proposed transport assignments can be rated according to a customizable cost function as discussed in further detail below. Use of a parallelized environment can compensate for performance losses resulting from use of computationally expensive suggestion finder algorithms. On a multiprocessor machine, checks can be distributed over different processing units. Furthermore, the checks and evaluations are executed only when a user actively searches for transports. In general therefore, the operations of FIG. 1 can be conducted for one user (a relatively small number of users) at a time, thereby taking advantage of not all users searching for additional transports simultaneously to provide improved performance of the transport management system.

Ad-hoc logistics advantageously includes capabilities for spontaneously adding transport assignments to a driver's route calendar. While a driver and/or a logistics network such as a carrier company is generally motivated to conduct additional transports to use resources more effectively, it has to be ensured that the driver is still able to execute all other transport assignments on his or her route calendar. Existing transport assignments in a driver's route schedule may have already undergone an optimization process, for example via software implementing one or more currently available tour or route management approaches. Integration of an ad-hoc application into an existing tour or route management software environment is desirably achieved without negatively affecting the other transport assignments in a driver's route calendar.

As noted above, a route calendar for a driver potentially includes multiple transport assignments, each including a start location (e.g. a pickup location) and an end location (e.g. a dropoff location). Both locations have an earliest and a latest time of arrival (e.g. defining an available pickup or delivery time window). The current subject matter can find additional feasible transport assignments that the driver can add to his or her route calendar and thereby use the truck more efficiently and to better profit financially from an added transport assignment.

To include and respect the existing transport assignments in a driver's route calendar to achieve this integrability, it can be necessary that the data relating to previously scheduled (e.g. existing) transport assignments is present on or accessible to a device (e.g. the driver's mobile device, a computer, etc.) used by the driver to access the transport management system. In some examples, this device is a mobile device, for example, a tablet or a smartphone, used by the driver to keep track of his or her route calendar. The transport management can be allowed read and write access to the calendar of the driver, which can be stored locally on the mobile device and/or accessed via a networked service (e.g. Google Calendar, Microsoft Exchange Server, an iCal server, etc.) to extract the relevant information and/or to add new transport assignments selected via the transport management service to the route calendar.

When adding a new transport assignment to a driver's existing route calendar, the question of how to insert the new loading locations in the existing sequence of already planned locations arises. As discussed below, different sequences of locations (suggestions) can have an impact on the profit, the risk, and the feasibility of the resulting modified route calendar. It is likely that a driver can only conduct a small selection of suggestions for additional transport assignments because some sequences of locations make the resulting modified route calendar non-profitable. A best suggestion (e.g. based on the evaluation and rating process, which is discussed in more detail below) can be found consistent with implementations of the current subject matter and inserted into the driver's route calendar.

To find possible sequences, the transport management system can first examine the temporal dimension of the space-time problem first. Each loading (and possibly each unloading) location has an earliest and a latest arrival time parameter (e.g. defining a pick-up and/or dropoff window). With these data, possible sequences of locations can be found because the time windows for a location are fixed and must not be violated. Therefore, first using time parameters to generate suggestions can be advantageous in initially excluding temporally impossible transport assignments. Reachability of a location (e.g. based on expected travel times and a preceding location in the in route calendar) can be used to check a proposed sequence of locations.

A computationally cheap method for determining suggestions for can include sorting all locations by, for example, their earliest time of arrival (or their latest time of arrival). After ordering this sequence of locations, the transport management system can check whether a given suggestion is feasible for a driver when all relevant constraints and restrictions are respected. However, a simplified approach, such as this one, for adding an additional transport to the route calendar might not result in the optimal solution in terms of waiting time, potential delay, or shortest travel distance (and therefore cost and profit). For this reason, more complex methods of finding suitable suggestions can be advantageously used with implementations of the current subject matter.

A variety of suggestions for a driver's route schedule can be derived by selecting a random point of time from every loading time interval (every location is treated as a time interval in the implementation with an earliest and a latest time of arrival denoting the size of the interval). Multiple random selections of a timestamp for every interval can create different suggestions for possible tour calendars. All suggestions can be checked to verify that no constraints are violated and those that pass this validation can be ranked based on their estimated profit, risk, etc. (e.g. one or more ranking criteria). An advantage of this approach is that the generation of suggestions is very fast. However, this process does guarantee an exhaustive list of all possible suggestions (except for an infinite number of randomized guesses). Furthermore, multiple runs of the process can result in equally ranked suggestions, which can be inefficient for a larger transport management system.

A driver's route calendar typically does not contain transports for more than two weeks. Accordingly, computationally more expensive methods can be implemented. An approach that always returns an exhaustive list of suggestions, and that therefore always finds the optimal solution when inserting a new transport assignment to the driver's route calendar can therefore be used. Such an approach can be beneficial for a carrier that is interested in finding the optimal solution, even when the runtime of the process is a bit longer than other possible approaches.

A transport management system having features similar to those described herein can respect constraints imposed by existing route management approaches such that the current subject matter can be integrated into an existing logistics software environment. For example, insertion of additional transport assignments into the driver's calendar may require a complete schedule for the driver and/or one or more other drivers to be restructured to allow timely execution of all transports. By addressing the same requirements as existing planning and optimization software, results can be integrated and conducted by drivers and carriers without disrupting a transport chain. Optimizing transport schedules can require solving of space-time or at least time related problems. Testing whether a driver can reach all locations in his or her calendar includes time checks along with spatial distance calculations. An optimal solution can thereby be derived for a set of spatio-temporal optimization problem by finding and testing different suggestions for driver tour (e.g. route) calendars while respecting a set of existing constraints.

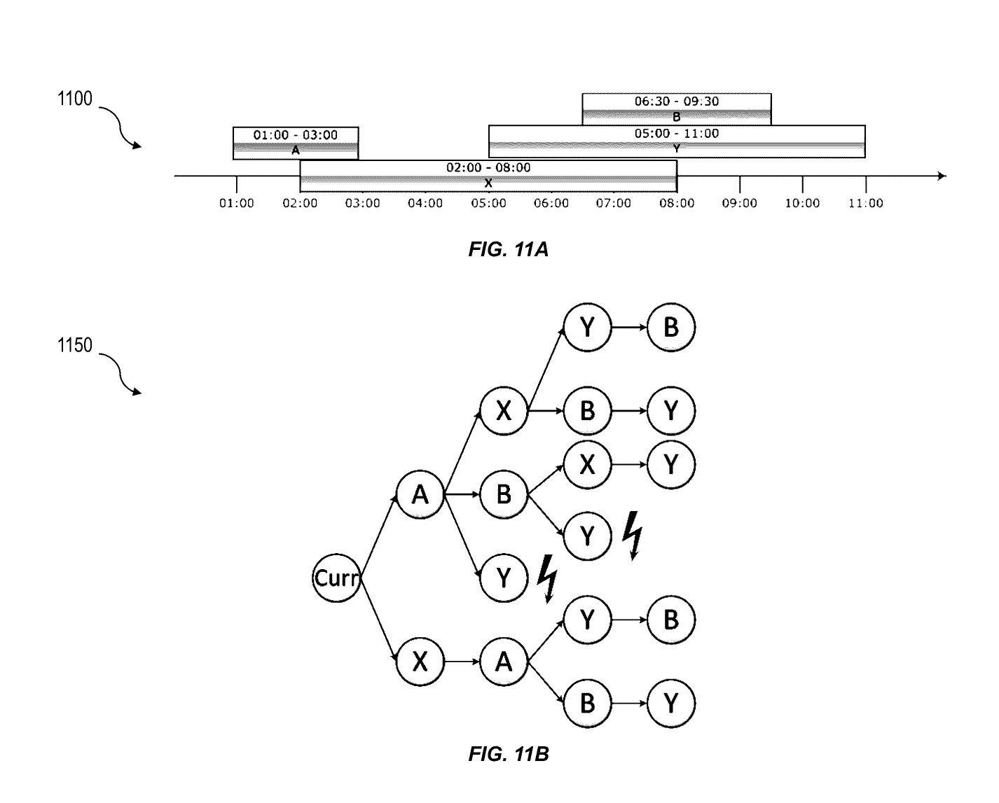

Certain features of the current subject matter can be understood by reference to the following two examples. In a first example, which is illustrated by the calendar view 1100 of FIG. 11A, a driver already has a transport in his or her calendar from location A to location B. For location A, the earliest allowable arrival time is 01:00 and the latest is 03:00. A transport management system checks whether transport X-Y can be taken by the driver as well. The transport is inserted into the calendar of the driver, which creates the scheduling situation depicted in FIG. 11A. The time windows for the locations overlap with each other so there are multiple possibilities to order them in a route schedule for the driver. For this particular example, there are five possibilities for temporally arranging the four locations:

A X Y B

A X B Y

A B X Y

X A Y B

X A B Y

A computational approach consistent with implementations of the current subject matter can be visualized with the help of a tree structure. A tree 1150 showing all possibilities to arrange the locations is shown in FIG. 11B. From the current position of the driver (“Curr”), there are five possibilities to arrange the locations as noted above. Each path through the tree, starting from the root node “curr” to a leaf containing all locations of the calendar, represents a suggestion for the insertion of the additional transport assignment. In FIG. 11B, one also sees two invalid paths which are market with a lightning symbol. In both of those paths, the end location Y would be in the sequence before its related start location X, so the truck would drive to the end location first which does not make sense for the execution of the transport assignment. Such situations are recognized as invalid and eliminated without further computational effort. As soon as all locations are included in a path and no violations occurred for the path, the suggestion can be added to the list of possible solutions. The maximal height of the tree is the amount of locations in the calendar plus one (current position of the driver as root node). As already stated, the calendar of the driver normally does not include transports that are more than two weeks in the future. It is therefore assumed that calculating the complete graph for a driver's calendar can be done in an acceptable amount of time.

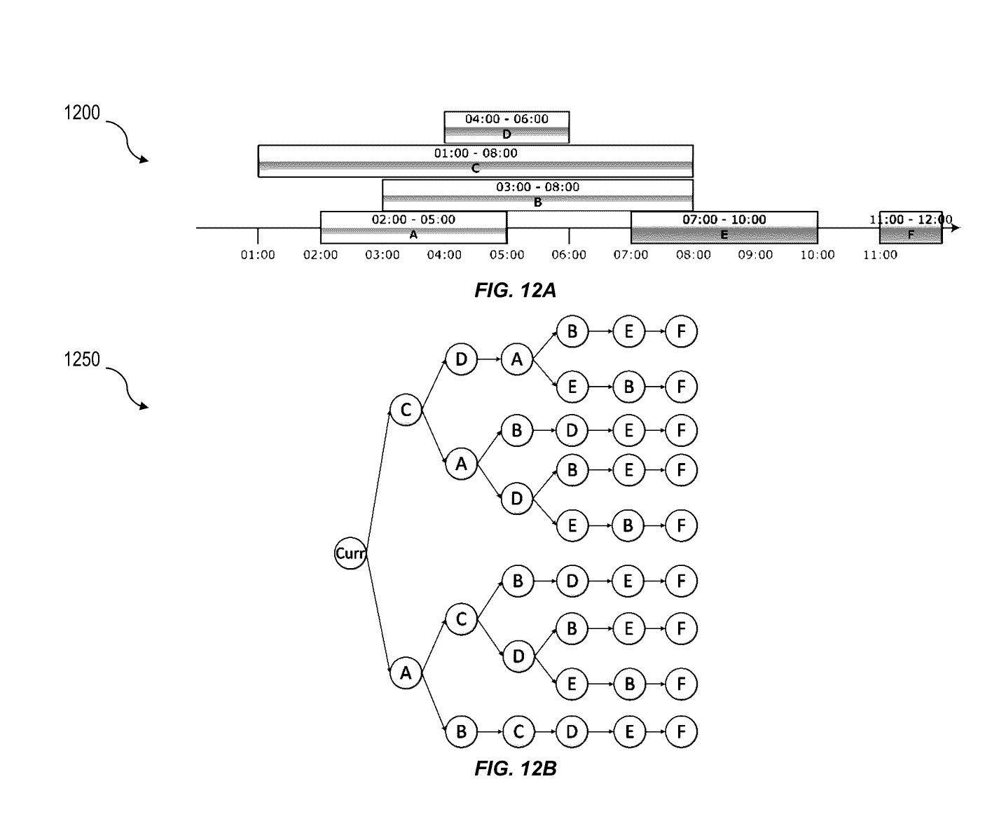

In a second example, which is illustrated by the calendar view 1200 of FIG. 12A, a driver already has transports A-B and C-D in his or her route calendar. In this example, there is significant overlap in the allowable time intervals. The nine possible suggestions for a route schedule if transport E-F is inserted into the calendar are as follows:

C D A B E F

C D A E B F

C A B D E F

C A D B E F

C A D E B F

A C B D E F

A C D B E F

A C D E B F

A B C D E F

The graph output of this calculation is depicted in the tree 1250 of FIG. 12B. In FIG. 12B, only the valid suggestions are plotted for visibility reasons. The graph can grow large even for a small number of transports in the calendar. However, a situation in which all loading time intervals overlap like depicted in FIG. 12A is not expected to occur frequently.

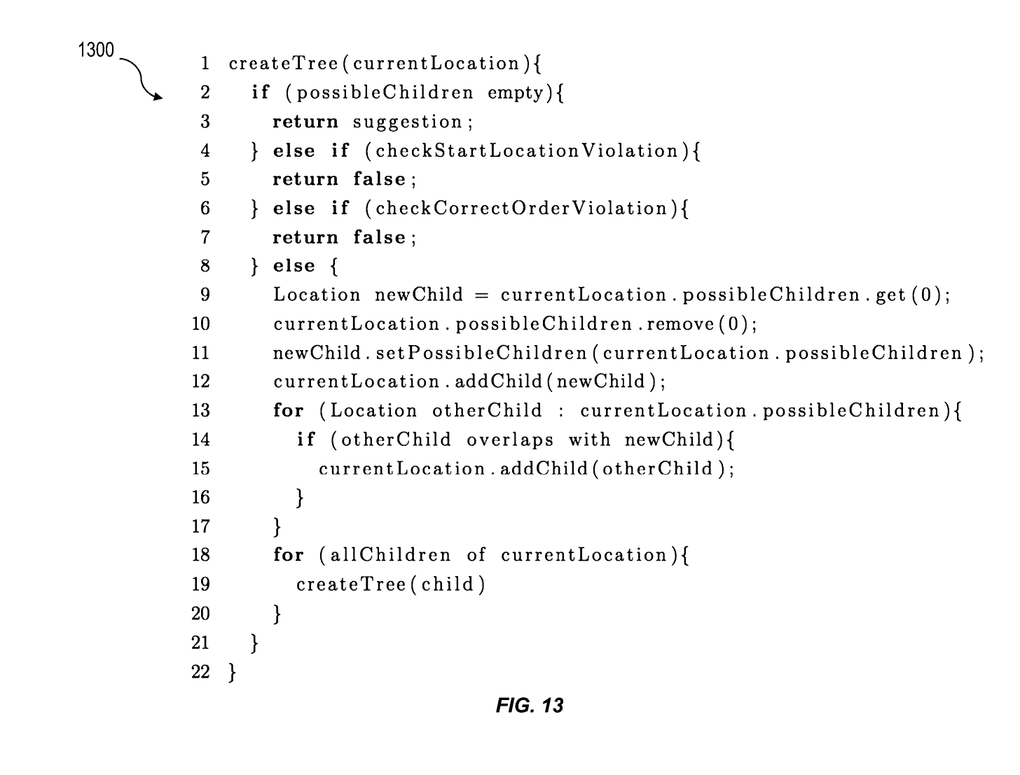

The generation of the graph is conducted with a recursive algorithm that is first called for the current position of the driver and then calls itself for all child nodes. FIG. 13 shows a pseudocode snippet 1300 illustrating an example implementation consistent with the current subject matter. The graph creation is called for the current position of the driver with the “currentLocation” parameter. Each node in the graph has a parent node (with the exception of the root node) and a list of child nodes, which is empty at the beginning Additionally, each node has a list of possible children, which includes all nodes that have not been called as the “currentLocation” parameter in the current path.

The algorithm is discussed now with the first example depicted in FIG. 11A. In the beginning, the “createTree” function is called for location “Curr”. The list of possible children of “Curr” contains all locations in the calendar 1150. So the list of possible children is not empty (cf. line 2 of the snippet 1300). The checks in lines 4 and 6 also do not result in a violation as discussed below. The algorithm now moves the first location (A) from the list of possible children to the children of “Curr”. Then, it moves all overlapping locations to location A to the children of “Curr” (in this step only location X). The “createTree” function is called for all children of “Curr” (A and X). The list of possible children of location A now contains locations X, B, and Y. The list of possible children of location X now contains locations A, B, and Y. The process terminates if the list of possible children is empty (cf. line 2).

Two checks can terminate the process for a specific path if there is a violation for this path. Those checks are called in lines 4 and 6. The check in line 4 terminates for the current path if the “currentLocation” is an end location and the related start location of the transport is not in the path yet. The second check in line 6 tests whether any location is forgotten in the path. This would be the case if the “currentLocation” had the time interval 04:00-06:00 and another possible child had the time interval 02:00-03:00. Obviously, the possible child has to be in the path before the “currentLocation”.

When the list of possible children is empty and no violation has occurred, the path is included into the list of possible suggestions for the tour plan. Then, the other components of the algorithm test and rate the suggestions to find the most profitable one as discussed in more detail below. In general, if a suggestion passes all tests, the driver can take the transport. All suggestions that pass the following checks and ratings can be compared to find the most profitable route schedule for the driver.

A graph representation and the recursive implementation can have certain advantages. Structuring the nodes in a tree can be an efficient way of storing the calendar information during the calculation because redundancies are omitted. Although calculating the tree might be slow in comparison to some heuristic approaches, it is more efficient than a brute force approach. An advantage of the recursive implementation and the graph algorithm is that the creation of the graph can be processed in parallel on multicore-architectures. The creation can be split over multiple cores, which can reduce the calculation time significantly. A parallelization is possible because the sub-trees are independent from each other and no data has to be shared between the subtrees of the graph. Additionally, this approach and its results are deterministic. For calendars that are on average not longer than two weeks, the tree does not become too large so the calculation can be acceptably fast.

The validating components of the algorithm are needed to test whether, for additional transport assignments and the calculated suggestions for these assignments, no requirements or restrictions are violated. To conduct a transport assignment, the vehicle and the stop locations of the transport have to be equipped with a number of items that are required for transporting or loading the cargo. If an equipment item is missing at a loading location or if a truck does not feature a required item, the transport cannot be executed. The equipment check of the implementation only suggests transports to drivers if the equipment constraints are not violated.

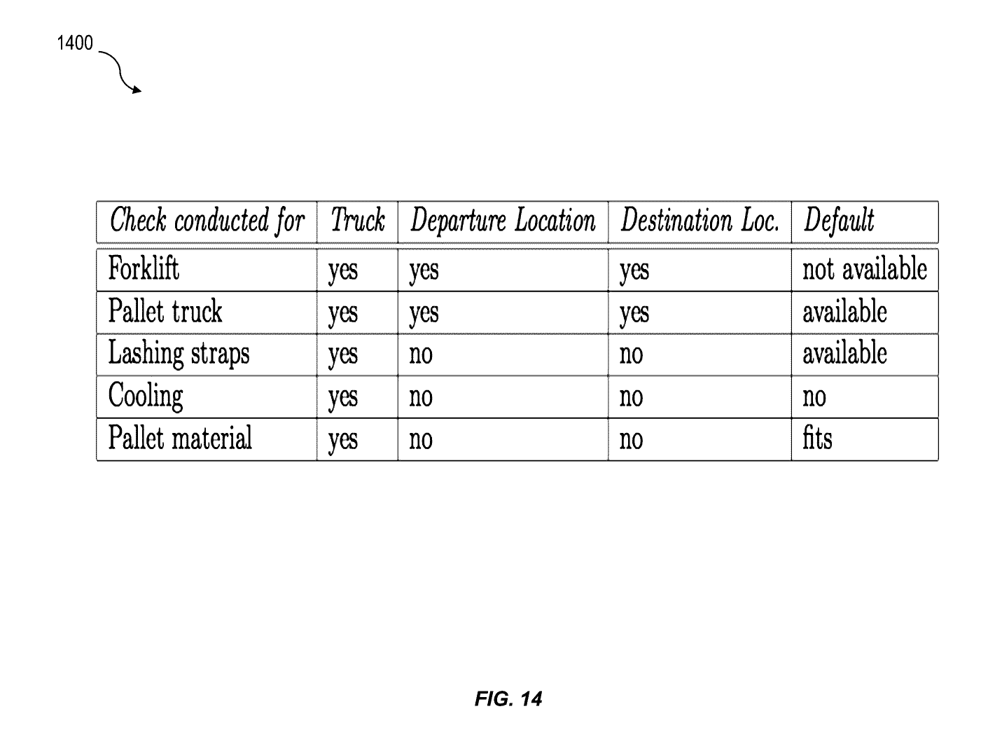

In general, checking the availability and suitability of the equipment for a transport order is a computationally cheap operation. The check does not depend on the order of the stop locations. Therefore, reordering the locations to optimize the tour plan does not have to be executed if the equipment check fails. Because of this, the equipment check is called before all other checks and also before the order of stop locations is optimized with regards to distance and time. An overview on the equipment checks that are executed by the implementation can be found in the table 1400 of FIG. 14. Realistic default values for the parameters can be selected to make the equipment checks as realistic as possible also when no parameters are specified by the carriers and the dispatchers. In the table 1400, “Yes” indicates that a parameter is checked for the truck or a location while “no” indicates that this parameter is not checked. The default column specifies the check result if no values are specified explicitly.

As an example, for certain types of cargo, forklifts are needed for loading and unloading. If the truck carries a forklift (e.g. a truck-mounted forklift), it does not matter whether a forklift is available at the loading locations. If a truck does not have a truck-mounted forklift, forklifts have to be available at both locations. As trucks generally do not frequently have truck-mounted forklifts, the default value (e.g. if the driver or dispatcher does not specify) can be no truck-mounted forklift. In contrast to that, a pallet truck is almost always available at a loading location. Therefore, if not explicitly stated otherwise by the dispatcher or the carrier, the pallet truck availability check succeeds. The same applies to lashing straps. Lashing straps are needed to secure the cargo in a trailer. This check only has to be conducted for the truck but as a default, it is assumed that lashing straps are available in every truck if not specified otherwise.

Furthermore, some cargo items need cooling equipment in the truck, for example food or certain drugs. This check is only executed for the vehicle and as a default value, it is specified that a truck does not have cooling equipment to control the temperature of the cargo. The last equipment check can control whether the pallet material fits the cargo items. Some cargo items are not allowed to be shipped on metal pallets of certain trailers. As a default, it can be assumed that a cargo item can be transported on every trailer but if a restriction is specified for a transport order and if a driver with an incompatible truck searches for transports, those transports are not suggested to the driver.

When loading or unloading a truck at a stop location, the location's physical loading structures have to fit the truck's parameters. This is referred to as accessibility. A truck trailer combination that can only be loaded from the back, such as a semi-tractor pulling a box trailer, has to be loaded at a ramp that is equipped with a fitting loading bridge. If these accessibility constraints are not met by truck or loading location, the transport is not suggested to the driver. Again, as for the equipment checks, the accessibility parameters might be unknown or simply not entered by the users because of laziness or lack of knowledge. In this case, also for usability reasons, the transport is proposed to the potential driver but the risk value for this transport is increased.

A trailer can be accessed from the side, the rear end, from all sides, or without any types of ramps or loading bridges. A location, for example a terminal or a warehouse, can feature multiple kinds of loading facilities. Ramps for rear or side loading, forklifts, or no ramps at all might be located at those locations. The transport management system can compare the accessibility possibilities of truck and location. If an incompatible combination is detected, the transport order is not suggested to the driver, and the temporal tree structure analysis described above is not conducted for that transport assignment.

To exemplify the load order problem, a small example is discussed in this section. If one assumes that a driver has two transports (from A to B and from C to D) in his or her tour calendar and additionally wants to take a transport from E to F, many combinations of ordering the locations are possible and have to be evaluated. An invalid order of locations would be

A B F E C D

In this example, the end location would be earlier than its related start location. This invalid combination is already filtered out by the suggestion finders, but other invalid combinations are possible as well:

A C D E B F

A C E D F B

The first suggestion leads to a load order problem at location B, because the cargo that is loaded at location E is in the way. In the second suggestion, the load problem occurs at location D where again the cargo of E is in the way. There are many valid combinations possible as well. Examples for such suggestions would be:

A C E F D B

A C D E F B

A B C E F D

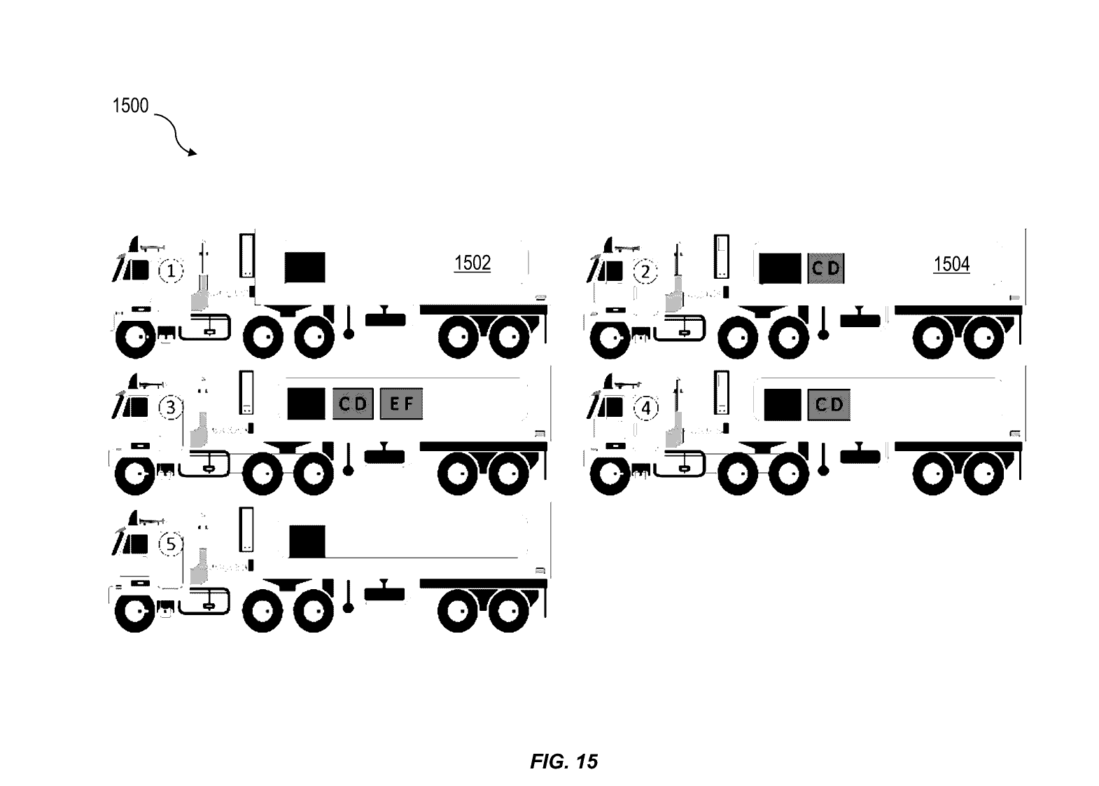

FIG. 15 shows a diagram 1500 illustrating how the trailer would be used for the first valid suggestion (e.g. A C E F D B) during the five runs between the locations. For other combinations, analogous figures can be created. The first truck 1502 shows the loading situation after the departure from location A. The cargo item that should be transported from A to B is loaded into the trailer. The second truck 1504 shows the situation after departing from location C and so on. In this example, the load order is not violated by the sequence of locations.

For all suggestions that are evaluated if a transport is checked by the transport management system, a load order test can be conducted because all suggestions differ in the sequence of locations. From an implementation point of view, it does not make a difference to whether a location belongs to a previously optimized transport or the one that is tested as a candidate for an additional transport.

A load order check can make use of a stack to keep track of the cargo that is loaded and unloaded for a suggestion. While iterating through the suggestion, all start locations can be put on top of the stack. If the next location is an end location, the algorithm checks whether this end location belongs to the same transport as the start location that is on top of the stack. This way, the load order for a suggestion can be checked while iterating through the suggestion only once.

For some vehicle types, the order of loading and unloading cargo items is a relevant issue. While creating a tour plan for a truck that can, for example, only be loaded and unloaded through the back door, the load order of cargo items has to be considered. If this is not done, a driver might have to unload a complete truck to be able to reach the cargo item that has to be unloaded at the current location. If using an ad-hoc logistics marketplace such as can be supported by implementations of the current subject matter meant unloading and loading cargo for several hours only to execute one additional transport, this would contrast the goal of integrating the ad-hoc implementation into the existing logistics environment. In addition, load order is not an issue for every vehicle, which is why the implementation provides a setting to turn the parameter check on or off. For most vehicles, unloading in reverse order in comparison to loading cargo items is the normal procedure.

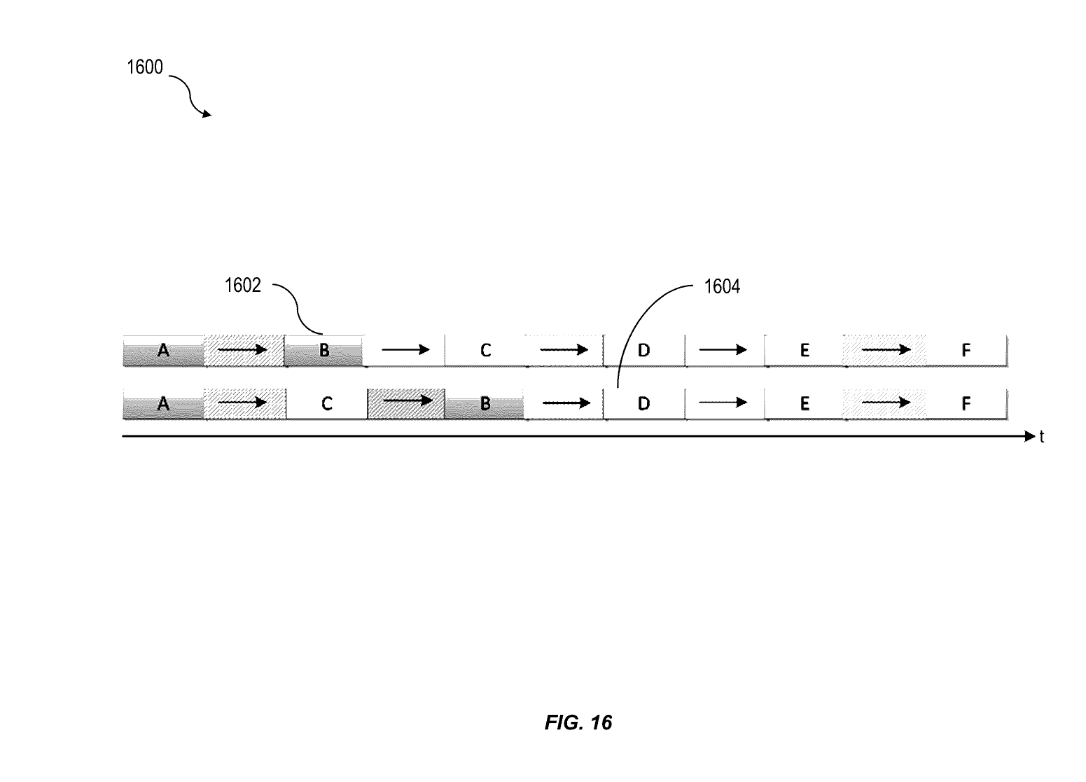

Free capacity (in terms of weight) and free dimension (volume) are two parameters that can be checked consistent with implementations of the current subject matter. The average capacity utilization can differ significantly from the dimension utilization. Therefore, both parameters can be checked for each suggestion proposed by a suggestion finder. In the chart 1600 of FIG. 16, for two suggestions with different location-sequences, the capacity and dimension values differ during the hypothetical execution of the suggestion. There are three transports in the calendar (A-B (in red), C-D (green), and E-F(purple)). If the sequence of locations is arranged as in the upper suggestion 1602, there are empty runs between B and C and between D and E. But the suggestion finder could suggest the second sequence 1604 as well. Here, the driver loads cargo at location A and C before unloading at B and D. This results in the situation that both the cargo of transport A-B and transport C-D have to be transported simultaneously on the way from C to B. The transport management system can check whether the sum of all “parallel” capacities during the execution of a suggestion does not exceed the trucks maximum capacity and dimension values.

A check of this kind can iterate through all locations of a suggestion and check the current capacity and dimension utilization against the truck's parameters. If a violation is detected by the transport management system, the suggestion is discarded. To make this check more efficient, the check can be included into other checks that have to iterate through the complete suggestion as well.

A transport management system can calculate whether a driver is able to reach all locations of a suggestion in time. To do so, additional time constraints such as loading time, waiting time, and buffers can be included into the calculation. Previously discussed features of the current subject matter involve finding an optimal suggestion only from a temporal perspective (e.g. arranging the locations in a feasible sequence with the suggestion finder). A time-constraints check can test whether the locations are reachable for the driver from a spatial and temporal point of view.

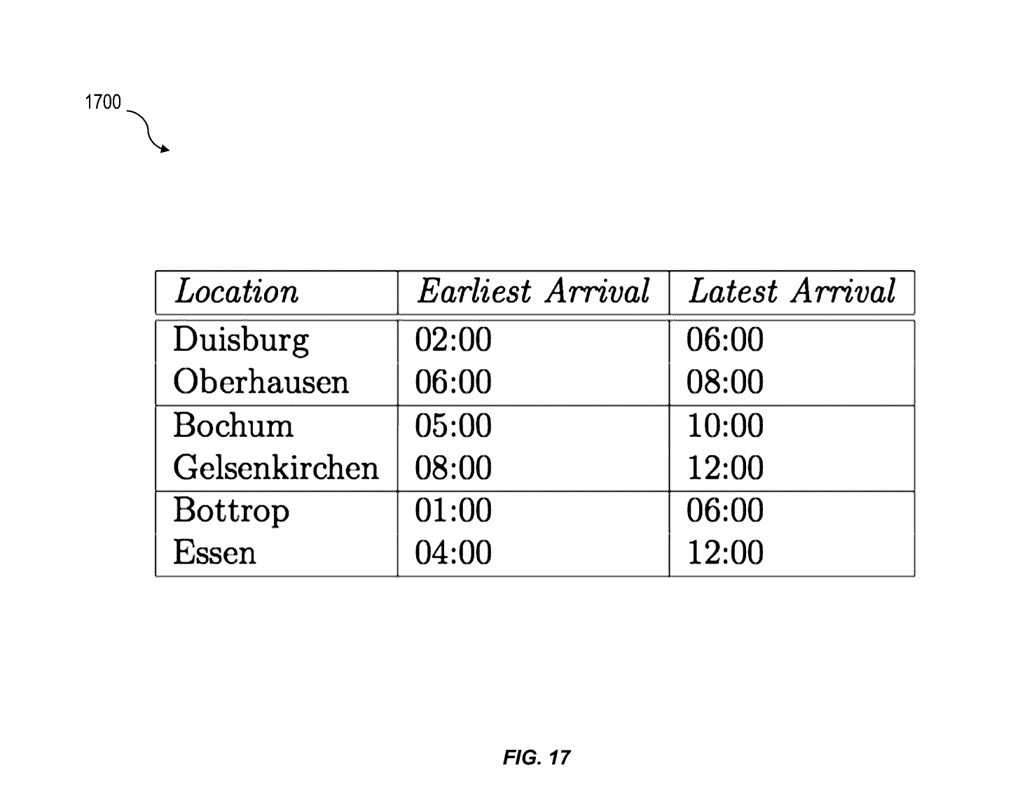

An example is helpful to understand the checks conducted for such a test. The Table 1700 of FIG. 17 shows a calendar of a driver. Originally, the driver has the two transports: from Duisburg to Oberhausen and from Bochum to Gelsenkirchen, in his or her calendar. The transport management system can check whether the transport from Bottrop to Essen can be taken by the driver as well. At each location, 15 minutes of loading time (or some other interval, which can be user-configurable) have to be respected. With the help of the suggestion finder, multiple suggestions with different location sequences are found. How the time constraint test inspects one of these suggestions to evaluate the feasibility of the suggestion is shown in the following example.

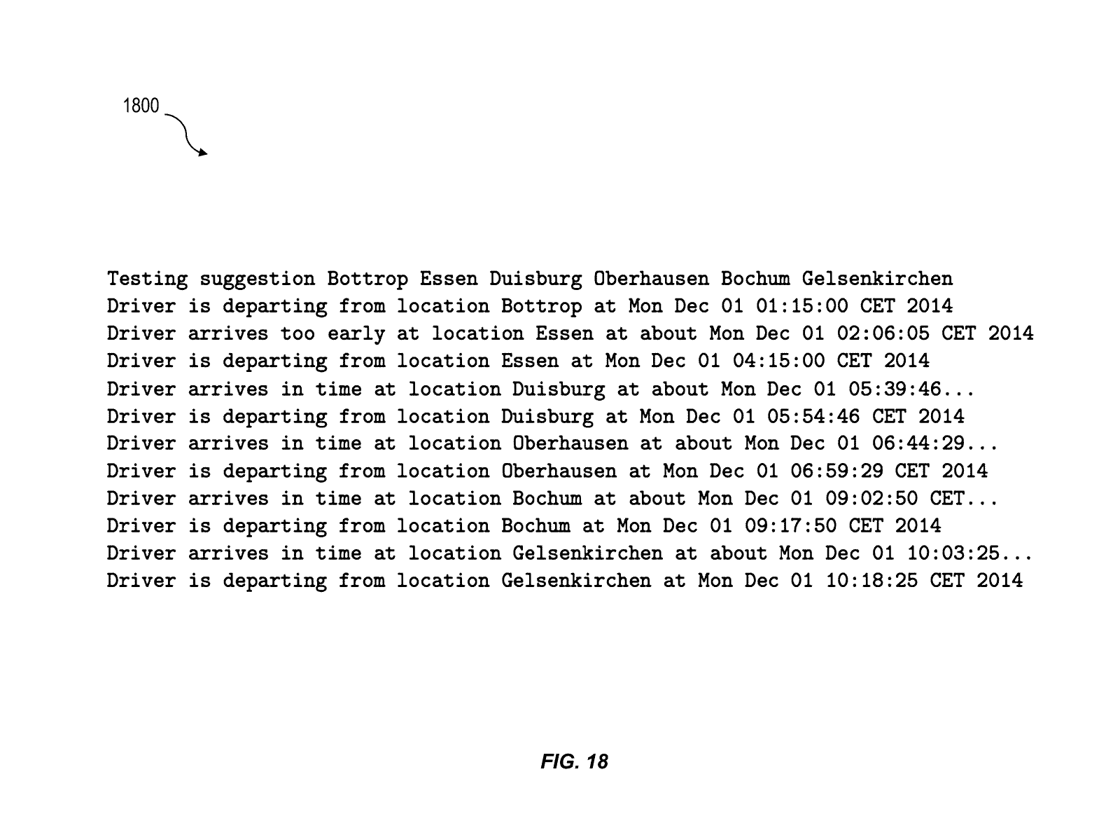

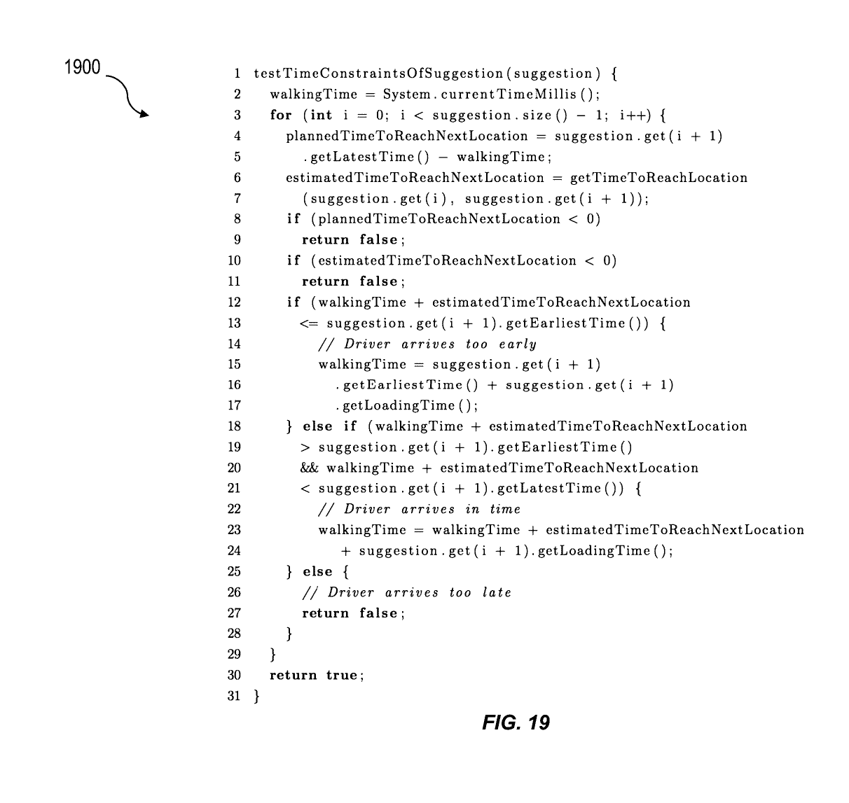

FIG. 18 shows a debugging output 1800. In the first row, a suggestion being tested is shown. The segment from the current position of the driver to Bottrop is not printed here but this part can be considered as well. This segment can be important if the driver is already delayed without even taking an additional transport. If the first location (in this example Bottrop) could not be reached in time, the suggestion would not pass the test either. The debugging output 1800 shows the estimated times of arrival for the tested suggestion. From comparing the time intervals from the schedule in the table 1700 of FIG. 17 with the estimated arrival and departure times in FIG. 18, it can be seen that this suggestion can be conducted by the driver. The driver either arrives too early at a stop location (and therefore has to wait before driving to the loading area) or arrives in time (within the borders of the specified time interval). A simplified pseudocode snippet 1900 is shown in FIG. 19 to explain how this check is implemented.

The “testTimeConstraintsOfSuggestion” takes the suggestion with the sequence of locations from the suggestion finder and checks the reachability for each location of the suggestion. While iterating through the suggestion, a variable “walkingTime” can be updated permanently. The execution of the suggestion can be simulated by the transport management system. In this simulation, the “walkingTime” variable represents the estimated timestamp during the execution and can be increased every time a truck would drive for a certain time or when it is loaded or unloaded at a location. By comparing the “walkingTime” with the timestamps that are defined in the tour plan for each location, it can be determines whether the driver could reach all locations of the suggestion in time. While iterating through the suggestion, the function calculates and compares two values for each route segment between two locations. The value “plannedTimeToRe-achNextLocation” (cf. line 4) is the amount of time that is still left from the current time during the simulated execution (“walkingTime”) and the latest time of arrival at the next location. The value “estimatedTimeToReachNextLocation” (cf. line 6) is the estimated time that the driver needs to reach the next location. The calculation of this estimated value is explained later. By comparing the “plannedTimeToReachNextLocation” and “estimatedTimeToReachNextLocation” values, it can be determined whether the driver could reach the next location in time. Lines 8-11 include a check whether the two values are positive (which means they do not lay in the past at that point of the simulation). Then, the transport management system can differentiate between three possibilities: A driver might arrive one of too early, on time, or too late.

If a driver arrives too early at a location (cf. line 12-17), he or she will have to wait before entering the loading area. A driver can use this waiting time to conduct breaks if driving time regulations apply to his or her vehicle, as discussed below. If a driver arrives too early, the departure time (which is then the new “walkingTime”) of the location is the earliest time of arrival at the location plus the loading time. If a driver would arrive between the earliest and the latest time of arrival, the arrival can be treated as being “in time”. If a driver arrives in time, the new “walkingTime” is the time of arrival at the location plus the loading time. If a driver would arrive after the latest time of arrival of the next location, this suggestion can be dropped because the driver would be too late. This check is conducted for all locations of the suggestion while iterating through the sequence of locations.

To save computing time, the other checks like load order, capacity, dimension, and driving time, can also be checked in parallel during this iteration process. In this manner, it is necessary to iterate through the suggestion once and not separately for every check. Buffer times, which occur every time a driver has to wait, can be calculated as well. This buffer, which is also referred to as “slack”, can help in rating the suggestion. Comparing buffer times between multiple suggestions can give a hint whether a suggestion is more likely to be disrupted by a small delay. In general, having enough slack time between the loading and driving segments decreases the risk associated with the suggestion.

As already mentioned, the transport management system also checks an initial delay that can occur if a driver is already delayed before taking the additional transport. This situation is likely to occur in the ad-hoc scenario because a driver can also take an additional transport if he or she is already on the way and executing a tour plan. In such a case, the transport management system has to make sure that despite the delay, the additional transport does not increase the driver's delay even more and that all locations can still be reached in time. If the delay cannot be compensated, the transport management system does not suggest the additional transport to the driver. If it suggested the transport despite knowing that it cannot be conducted in time, both the driver and the dispatcher might suffer from a financial loss.

Calculating the “estimatedTimeToReachNextLocation” variable in the check can be a difficult task. One solution can be to query an external routing service that can precisely estimate the driving time. On the other hand, a large number of queries, as it had to be conducted for this transport management system, would need a long time to be executed and transmitted. Although duplicate queries can be omitted by caching results of previous queries, the runtime of the transport management system might increase drastically. Additionally, if there is enough slack, a precise calculation might not be necessary to say that a driver can reach the next location. In other cases, it might be obvious that a driver can never reach a location in time, also without querying an external service. For those cases, an offline estimation that only calculates the orthodromic distance between the locations and then estimates the driving time with an average speed value is sufficient as well. A hybrid approach that primarily relies on this simple estimation can be used with implementations of the current subject matter. In cases where a precise calculation is needed, for example when there is not much slack available, a routing service can be queried. The queries can be modified with a vehicle parameter so that the calculation takes into consideration that, for instance, heavy trucks cannot drive on certain roads and are moving more slowly.

Driving time regulations that apply for vehicles in the European Union (EU), the United States, and elsewhere can include complex sets of rules and restrictions. For example, in the EU, all vehicles with a weight of over 3.5 tons have to comply with the driving time regulations EC No 561/2006. Accordingly, implementations of the current subject matter can ensure that, as part of an addition of a new transport assignment to a driver's schedule ensure that if a driver has to follow the driving time regulations with his or her vehicle, the calculation of the time constraints and the tour plan is adjusted accordingly. An additional transport should only be suggested to a driver if he or she can execute the additional transport while respecting the driving time regulations. For the drivers, this check means a helpful assistance when selecting additional transports. Furthermore, this check can help to filter out nonserious transport demands as well. If only feasible transports are suggested to the driver, he or she does not have the possibility of willingly or unwillingly violating the driving time regulations during the execution of the transport plan. For an EU implementation, the transport management system can therefore verify that the suggested route plan satisfies the following constraints (e.g. compliant with EC No 561/2006): the daily driving time of a driver is not allowed to exceed 9 hours, a driver has to conduct an uninterrupted break of 11 hours per day, every 4.5 hours, a driver has to take a break of 45 minutes, driving on Sundays and public holidays is not allowed without a special permit, and if two drivers drive one vehicle all rules except the short break rule apply.

Suggestions that are not feasible without violating the regulations are not presented to the driver. The checks for the driving time regulations can be implemented in a manner similar to the time constraint and reachability checks described above.

Each time a small break is required during the execution of a route schedule, the “walkingTime” parameter is increased accordingly. Such a break can lead to the situation that a driver cannot reach the next location in the route schedule, in which case the transport management system can drop the suggestion. Because driving time regulations can be conducted together with reachability checks, the waiting times can be used as small or long breaks. Furthermore, this influences the buffer values because the slack decreases for every break that is necessary. If a dispatcher enters a new transport that cannot be executed without violating driving time regulations, he or she should also receive a warning so that the time windows for the locations can be adjusted accordingly. Otherwise, the transport management system would never suggest the transport to a driver while the dispatcher is not aware of the situation that the transport order is violating the driving time restrictions.

If no constraints are violated by a suggestion, the transport management system outputs a rated suggestion. As noted above, the rating can be based on maximizing financial profit and can enable comparison of one valid suggestion to another. The highest-rated suggestion can be proposed to the driver and written into his or her modified route calendar. A rated suggestion includes the sequence of locations that make out a route plan as well as additional rating and evaluation parameters. Rated suggestions that are returned by the validators are always valid in terms of feasibility. This means that a driver could reach all locations in time, no constraints are violated, and the driver would profit financially from taking the additional transport. To compare the various suggestions with the different sequences of locations, evaluation parameters are calculated. A rated suggestion therefore holds information concerning one or more of sequence of locations (schedule for the driver), time-buffer/slack, cost, expected profit; and risk.

After the rating components calculated the parameters for the different rated suggestions, the most profitable one can be suggested to the driver. All rated suggestions are feasible and successfully passed all checks. However, modifying a route schedule and comparing multiple suggestions for a route schedule can have a significant influence on the expected profit. For example, for every rated suggestion, distance, slack, and cost, and therefore also expected profit, can differ. In principle, as soon as at least one rated suggestion is created, the driver can take the additional transport. However, creating multiple rating suggestions and comparing them oftentimes is a beneficial option for the user.

A precise cost calculation can be influenced by many parameters. With equal distance, according to the formula, more cargo results in more profit for the carrier. This leads to a reduced price for the dispatcher as well, because the price per item decreases. In the use case with an additional ad-hoc transport however, the distance is not equal but generally increases due to inclusion of one or more additional destinations within a driver's route. The loading and unloading times can also increase within inclusion of additional transport assignments, so this additional cost has to be included in the profit calculation, too. In some examples, a carrier can negotiate a fixed price per distance (e.g. per km, mile, etc.), and a transport management system consistent with implementations of the current subject matter can include a per distance price field (or optionally a flat fee) for specifying the value to be paid to a driver for taking on a given transport assignment. For a profit calculation, the actual additional cost to a driver for an additional transport assignment can be influenced by the detour distance (e.g. additional distance traveled) due to inclusion of the transport assignment), the detour time (e.g. the additional time spent) associated with inclusion of the transport assignment, and any additional fuel consumption per distance traveled associated with inclusion of the transport assignment (e.g. if additional weight of added cargo leads to a higher fuel consumption). In some examples, the additional fuel consumption can be omitted without significant loss of accuracy. Profit is then the price for the transport assignment minus the increased costs in distance, time, and/or fuel consumption. The transport management system can omit transport assignments that result in a negative profit for the driver and can use positive profit values as a ranking criteria for a set of two or more transport assignments (e.g. with higher profit assignments ranked more highly).

An additional rating criteria for additional transport assignments to be proposed to a driver can include a risk ranking For example, these ratings can include risks of disruption of the supply chain when taking the additional transport. One or more parameters and checks can influence the risk assessment. If a test reveals a potential risk for the execution of the transport, the risk value of the rated suggestion is increased. A slack time can be calculated for each rated suggestion and included in the risk assessment as well. Risk values can be increased for situations such as when equipment parameters are not specified or not known, accessibility specifications are unknown or not entered, a slack or buffer time in a driver schedule is too small (e.g. below some threshold amount that can be specified by a dispatcher, manager, the driver, etc.).

If a driver decides on taking an additional transport assignment, his or her schedule is updated. The driver requires detailed scheduling information to execute all transports successfully because his or her complete calendar might be restructured by the transport management system. A schedule creator component (or similar functionality) of the transport management system can perform this task. Schedule generation can optionally be executed in parallel to the time constraint and driving time regulation checks. Based on the estimated driving times in the time constraint check, the schedule for the driver can be calculated on the basis of the estimated durations for each driving segment between the locations. The schedule can be exported into the driver's mobile device where he or she can access the calendar information and inspect driving and loading intervals in the calendar.

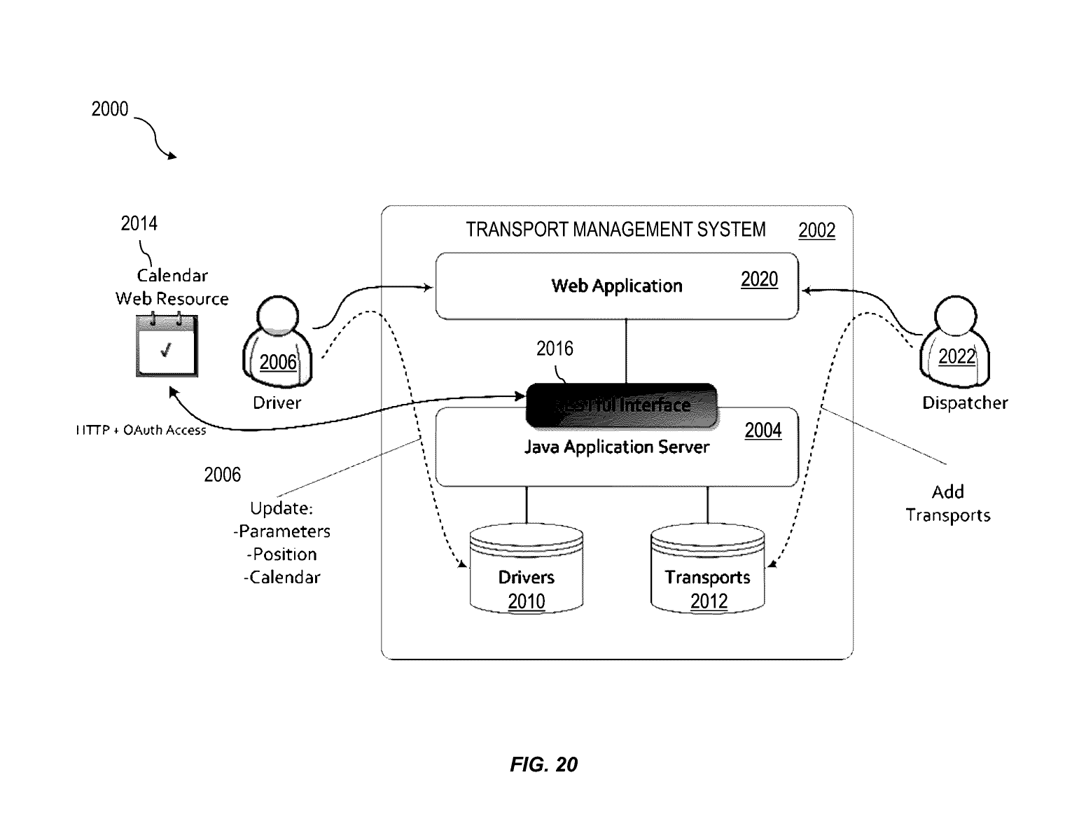

FIG. 20 shows an example of a computing architecture 2000 that can support one or more features of the current subject matter. A transport management system 2002 can include an application server 2004 (e.g. a JAVA application server) that operates with data obtained from one or more drivers 2006 and stored in a driver information database 2010 and also with a transport assignment database 2012. Data obtained from drivers 2006 can include truck capacity, included equipment, etc. (e.g. any parameter mentioned herein). The data obtained from a driver 2006 can also include calendar information, which can optionally be accessed from a calendar resource 2014, such as for example a calendar web resource, or some other scheduling app or application executing on the driver's mobile device and/or from a networked application used by the driver 2006. A driver's mobile device can upload the current position of the driver 2006 to allow a matching of transport assignment offers and demand on a spatial dimension as well. The application server 2004 can be accessible via a RESTful application programming interface (API) 2016, which can also retrieve and upload calendar data for a driver 2006, for example when the driver 2006 or other user is successfully authenticated through an OAuth authentication mechanism or the like. A web application 2020 accesses the application server 2004 via the RESTful interface 2016 when a dispatcher 2022 inserts a new transport assignment and/or when a driver 2006 searches for additional transports that are available. In some implementations of the current subject matter, the three tier architecture shown in FIG. 20 (e.g. the web application 2020, the application server 2004, and the databases (e.g. the driver information database 2010 and the transport assignment database 2012, which can optionally be parts of a single database) can be implemented entirely on a cloud-based database management system, such as for example the SAP HANA Cloud Platform available from SAP SE of Walldorf, Germany using in-memory database technology as well as cloud-based services for calendar management (for example to support existing calendar file formats such as iCal available from Apple Inc. of Cupertino, Calif.; Google Calendar available from Google, Inc. of Mountain View, Calif.; and Microsoft Exchange Server available from Microsoft Corp. of Redmond, Wash.).

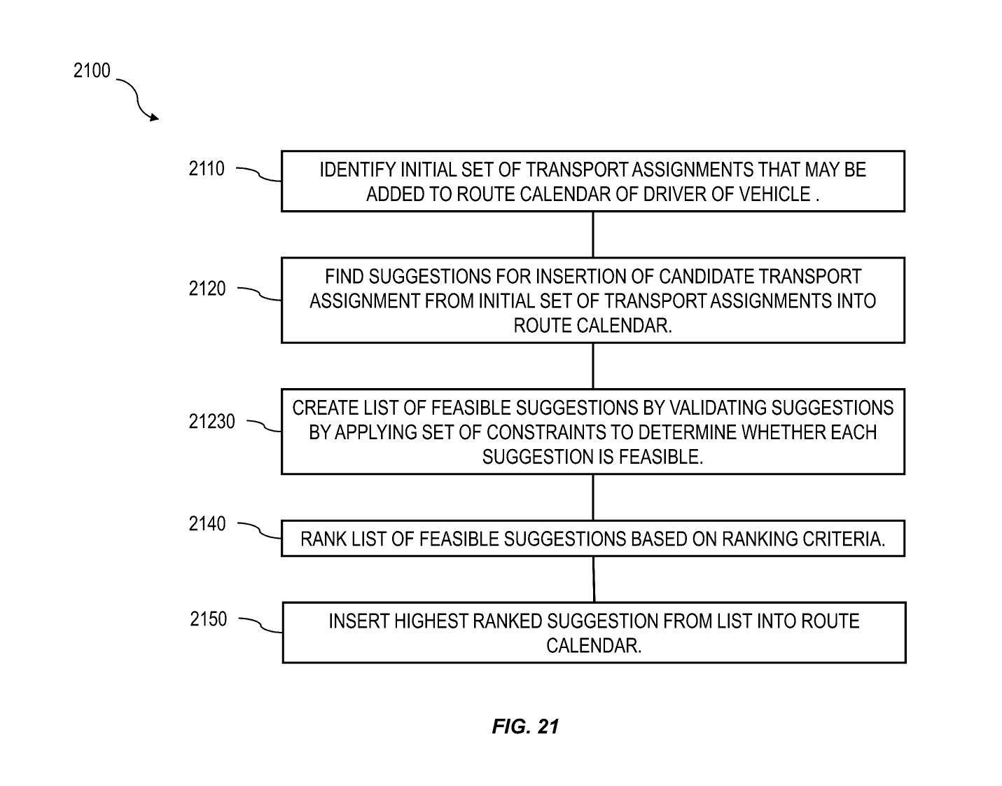

FIG. 21 shows a process flow chart 2100 illustration features that can be included in one or more implementations of the current subject matter. At 2110, a transport management system identifies an initial set of transport assignments that may be added to a route calendar of a driver of a vehicle. The identifying includes eliminating at least one potential transport assignment for which the vehicle does not meet equipment and/or accessibility criteria for a location associated with the potential transport assignment. At 2120, the transport management system finds suggestions for insertion of a candidate transport assignment from the initial set of transport assignments into the route calendar. The finding includes inserting the candidate transport assignment in all possible temporal combinations with one or more existing transport assignments in the route calendar. A list of feasible suggestions results at 2130 from validating the suggestions by applying a set of constraints to determine whether each suggestion is feasible. The list of feasible suggestions is ranked at 2140 based on one or more ranking criteria, and a highest ranked suggestion from the list is inserted into the route calendar at 2150.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory machine-readable medium storing instructions that, when executed by at least one programmable processor, cause the at least one programmable processor to perform operations comprising:
identifying an initial set of transport assignments that may be added to a route calendar of a driver of a vehicle, the identifying comprising eliminating a potential transport assignment for which the vehicle does not meet equipment and/or accessibility criteria for a location associated with the potential transport assignment;
finding suggestions for insertion of a candidate transport assignment from the initial set of transport assignments into the route calendar, the finding comprising inserting the candidate transport assignment in all possible temporal combinations with one or more existing transport assignments in the route calendar;
validating the suggestions by applying a set of constraints to determine whether each suggestion is feasible, the validating resulting in a list of feasible suggestions;
ranking the list of feasible suggestions based on one or more ranking criteria; and
inserting a highest ranked suggestion from the list into the route calendar.

2. A computer program product as in claim 1, wherein the operations further comprise accessing the route calendar from a mobile device of the driver and/or a cloud based service used by the driver.

3. A computer program product as in claim 1, wherein the set of constraints comprises both temporal feasibility and spatio-temporal feasibility.

4. A computer program product as in claim 3, wherein the set of constraints further comprises compliance with one or more driving time regulations.

5. A computer program product as in claim 1, wherein the validating comprises a recursive process via which all of the suggestions are considered.

6. A computer program product as in claim 1, wherein the ranking criteria comprise profit and risk.

7. A system comprising:
computer hardware configured to perform operations comprising:
identifying an initial set of transport assignments that may be added to a route calendar of a driver of a vehicle, the identifying comprising eliminating a potential transport assignment for which the vehicle does not meet equipment and/or accessibility criteria for a location associated with the potential transport assignment;
finding suggestions for insertion of a candidate transport assignment from the initial set of transport assignments into the route calendar, the finding comprising inserting the candidate transport assignment in all possible temporal combinations with one or more existing transport assignments in the route calendar;
validating the suggestions by applying a set of constraints to determine whether each suggestion is feasible, the validating resulting in a list of feasible suggestions;
ranking the list of feasible suggestions based on one or more ranking criteria; and
inserting a highest ranked suggestion from the list into the route calendar.

8. A system as in claim 7, wherein the operations further comprise accessing the route calendar from a mobile device of the driver and/or a cloud based service used by the driver.

9. A system as in claim 7, wherein the set of constraints comprises both temporal feasibility and spatio-temporal feasibility.

10. A system as in claim 9, wherein the set of constraints further comprises compliance with one or more driving time regulations.

11. A system as in claim 7, wherein the validating comprises a recursive process via which all of the suggestions are considered.

12. A system as in claim 7, wherein the ranking criteria comprise profit and risk.

13. A computer-implemented method comprising:
identifying an initial set of transport assignments that may be added to a route calendar of a driver of a vehicle, the identifying comprising eliminating a potential transport assignment for which the vehicle does not meet equipment and/or accessibility criteria for a location associated with the potential transport assignment;
finding suggestions for insertion of a candidate transport assignment from the initial set of transport assignments into the route calendar, the finding comprising inserting the candidate transport assignment in all possible temporal combinations with one or more existing transport assignments in the route calendar;
validating the suggestions by applying a set of constraints to determine whether each suggestion is feasible, the validating resulting in a list of feasible suggestions;
ranking the list of feasible suggestions based on one or more ranking criteria; and
inserting a highest ranked suggestion from the list into the route calendar.

14. A computer-implemented method as in claim 13, wherein the operations further comprise accessing the route calendar from a mobile device of the driver and/or a cloud based service used by the driver.

15. A computer-implemented method as in claim 13, wherein the set of constraints comprises both temporal feasibility and spatio-temporal feasibility.

16. A computer-implemented method as in claim 15, wherein the set of constraints further comprises compliance with one or more driving time regulations.

17. A computer-implemented method as in claim 13, wherein the validating comprises a recursive process via which all of the suggestions are considered.

18. A computer-implemented method as in claim 13, wherein the ranking criteria comprise profit and risk.
